(19) United States
(12) Patent Application Publication
(10) Pub. No.: US 2011/0284355 A1
(43) Pub. Date: Nov. 24, 2011

(54) Keyboard

(75) Inventor: Liang-Yuan Yang, Keelung City (TW)

(73) Assignee: Changshu Sunrex Technology Co., Ltd.

(21) Appl. No.: 12/782,802

(22) Filed: May 19, 2010

(51) Int. Cl. H01H 13/76

(52) U.S. Cl. 200/5 A

(57) ABSTRACT

A keyboard includes: a membrane circuit substrate; a press key set including a one-piece membrane and a plurality of rigid reinforcing plates, the membrane having a plurality of resilient keycap portions and a connecting portion extending among and interconnecting the keycap portions, the connecting portion being fixed to the membrane circuit substrate, the keycap portions protruding upwardly from the connecting portion, each of the keycap portions having a press wall, and a surrounding wall extending downwardly from the press wall to the connecting portion, each of the reinforcing plates being disposed over the press wall of a corresponding one of the keycap portions; and a plurality of elastic members each of which is disposed between the press wall and the membrane circuit substrate.

### BACKGROUND OF THE INVENTION

1. Field of the Invention

This invention relates to a keyboard, more particularly to a keyboard including a press key set having a one-piece membrane and a plurality of rigid reinforcing plates.

2. Description of the Related Art

In a conventional keyboard disclosed in Taiwanese Patent no. 509955, keycaps are mounted on a keyboard base of the keyboard using X-shaped link-levers such that the keycaps can move upwardly and downwardly relative to the keyboard base. Elastic members are disposed between the keycaps and a membrane circuit substrate and bias the keycaps upwardly.

However, by using the X-shaped link-levers, not only is the installation of the keycaps to the keyboard base relatively complicated, but the cost of the keyboard is also increased.

### SUMMARY OF THE INVENTION

Therefore, an object of the present invention is to provide a keyboard with a relatively simple structure that can be fabricated at a relatively low cost without adversely affecting touch feeling.

Accordingly, a keyboard of the present invention comprises:

a membrane circuit substrate;

a press key set including a one-piece membrane and a plurality of rigid reinforcing plates, the membrane having a plurality of resilient keycap portions and a connecting portion extending among and interconnecting the keycap portions, the connecting portion being fixed to the membrane circuit substrate, the keycap portions protruding upwardly from the connecting portion, each of the keycap portions having a press wall, and a surrounding wall extending downwardly from the press wall to the connecting portion, each of the reinforcing plates being disposed over the press wall of a corresponding one of the keycap portions; and

a plurality of elastic members each of which is disposed between the press wall and the membrane circuit substrate.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of the first preferred embodiment of a keyboard according to the present invention;

FIG. 2 is an exploded perspective view of the first preferred embodiment;

FIG. 3 is a fragmentary cross-sectional view of the first preferred embodiment in an assembled state;

FIG. 4 is an exploded perspective view of the second preferred embodiment of a keyboard according to the present invention;

FIG. 5 is a fragmentary cross-sectional view of the second preferred embodiment in an assembled state;

FIG. 6 is an exploded perspective view of the third preferred embodiment of a keyboard according to the present invention;

FIG. 7 is a fragmentary cross-sectional view of the third preferred embodiment in an assembled state;

FIG. 8 is an exploded perspective view of the fourth preferred embodiment of a keyboard according to the present invention; and

FIG. 9 is a fragmentary cross-sectional view of the fourth preferred embodiment in an assembled state.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

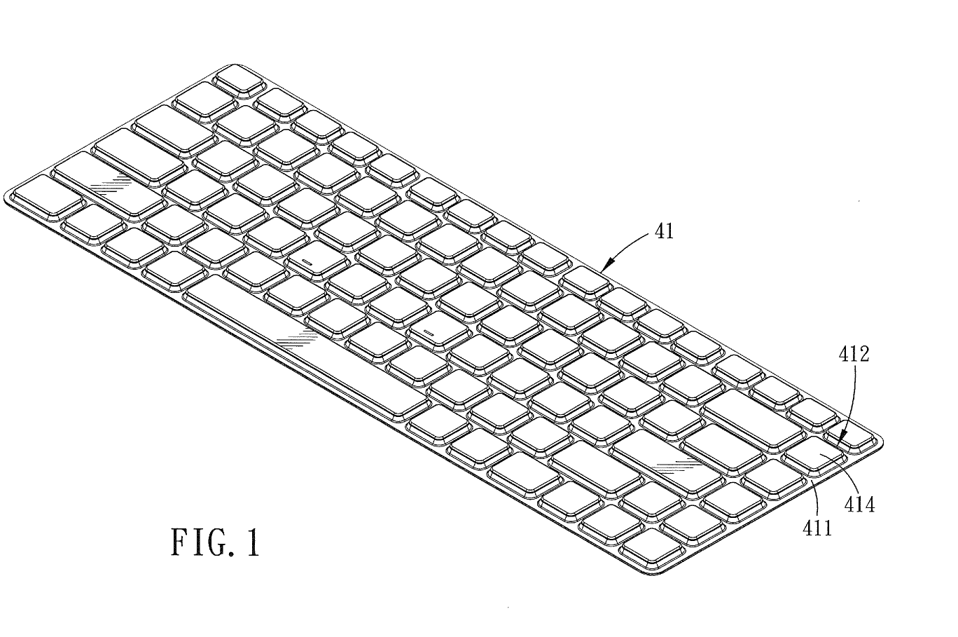

Referring to FIGS. 1 to 3, a keyboard according to the first preferred embodiment of the present invention is shown to include a keyboard base 1, a membrane circuit substrate 2, a plurality of elastic members 3, and a press key set 4.

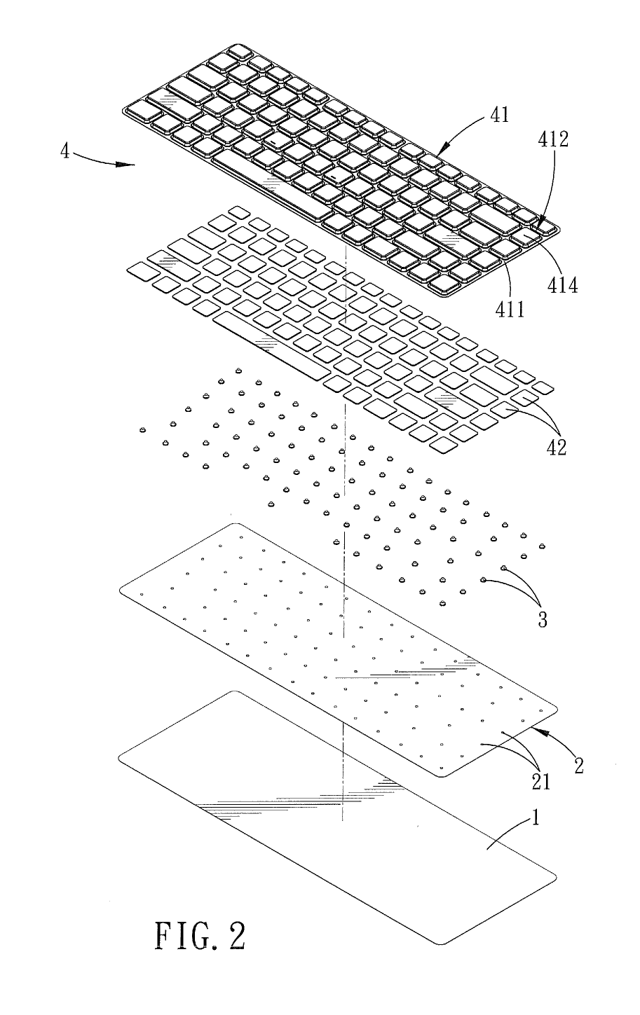

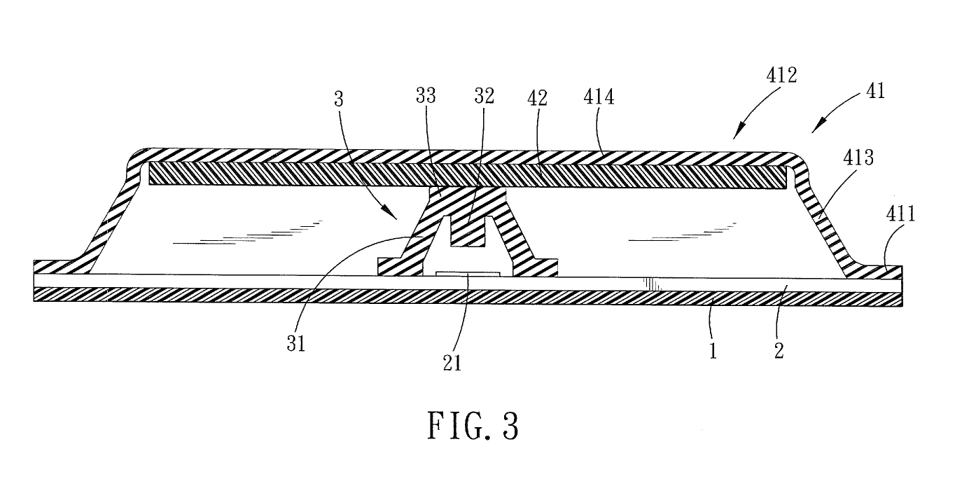

As best shown in FIG. 3, the membrane circuit substrate 2 is disposed on an upper surface of the keyboard base 1, and includes a plurality contact pads 21 (see FIG. 2) disposed apart from each other. The number of the contact pads 21 is the same as that of the elastic members 3. The elastic members 3 are fixed and adhered to an upper surface of the membrane circuit substrate 2 to respectively align with the contact pads 21, and can be made of natural rubber or synthetic rubber (e.g., silicone rubber). Each of the elastic members 3 has a surrounding wall 31 and a top wall 33 so as to cooperatively define a space. A protrusion 32 protrudes from the top wall 33 and extends into the space. When the elastic member 3 is pressed, the surrounding wall 31 is deformed to bring the corresponding protrusion 32 thereof into contact with the corresponding contact pad 21 of the membrane circuit substrate 2, such that an input signal is generated by virtue of the electrical connection between the protrusion 32 and the corresponding contact pad 21.

The press key set 4 includes a one-piece membrane 41 which is made of a soft material, for example, natural rubber or synthetic rubber (e.g., silicone rubber), and is disposed on the upper surface of the membrane circuit substrate 2. The one-piece membrane 41 includes a connecting portion 411 and a plurality of resilient keycap portions 412. The connecting portion 411 extends among and interconnects the keycap portions 412. The connecting portion 411 is fixed and adhered to the upper surface of the membrane circuit substrate 2 using, e.g., an adhesive. The positions and the numbers of the keycap portions 412 correspond to those of the elastic members 3. Accordingly, when the connecting portion 411 is adhered to the upper surface of the membrane circuit substrate 2, the keycap portions 412 will correspondingly cover the elastic members 3. Each of the keycap portions 412 protrudes upwardly from the connecting portion 411, and has a surrounding wall 413 and a press wall 414. The surrounding wall 413 of each of the keycap portions 412 extends downwardly from the press wall 414 to the connecting portion 411. The elastic members 3 are respectively disposed below the press walls 414 of the keycap portions 412. When the press wall 414 is forced to move downwardly, the corresponding surrounding wall 413 will be deformed accordingly, and the protrusion 32 of the corresponding elastic member 3 will be brought into contact with the corresponding contact pad 21 of the membrane circuit substrate 2. When the force applied to the press wall 414 is released, the press wall 414 will be restored to its original position (see FIG. 3) by virtue of the resilience of the corresponding surrounding wall 413 and the surrounding wall 31 of the corresponding elastic member 3.

Preferably, in order to enhance the hardness and the rigidity of the press walls 414 of the keycap portions 412, and in order to firmly support the press walls 414 at their original positions (see FIG. 3), the press key set 4 further includes a plurality of rigid reinforcing plates 42. Each of the reinforcing plates 42 has an area not larger than that of the press wall 414 of a corresponding one of the keycap portions 412. In this embodiment, the reinforcing plates 42 are disposed over and adhered to lower surfaces of the press walls 414 of the keycap portions 412 using, e.g., an adhesive. Accordingly, the hardness and the rigidity of the press walls 414 can be enhanced, and the press walls 414 can be firmly supported at their original positions. The reinforcing plates 42 can be made of any rigid material, for example, plastic materials, metals, or acrylic resins. In this embodiment, as shown in FIG. 3, the top wall 33 of each of the elastic members 3 presses against a lower surface of a corresponding one of the reinforcing plates 42. Alternatively, the reinforcing plates 42 can be designed to be spaced apart from the top wall 33 of the elastic members 3 at their original positions.

Since the one-piece membrane 41 is made of a soft material and has the reinforcing plates 42 respectively disposed over the lower surfaces of the press walls 414, a comfortable touch feeling of the press walls 414 for the user's fingers can be ensured, and pain due to frequent pressing of the press walls 414 during long-term use can be minimized. Furthermore, each of the press walls 414 can be supported on the corresponding elastic member 3 by the corresponding surrounding wall 413 without using the X-shaped link-levers of the prior art. Therefore, the keyboard of this invention has a relatively simple structure that can be fabricated at a relatively low cost.

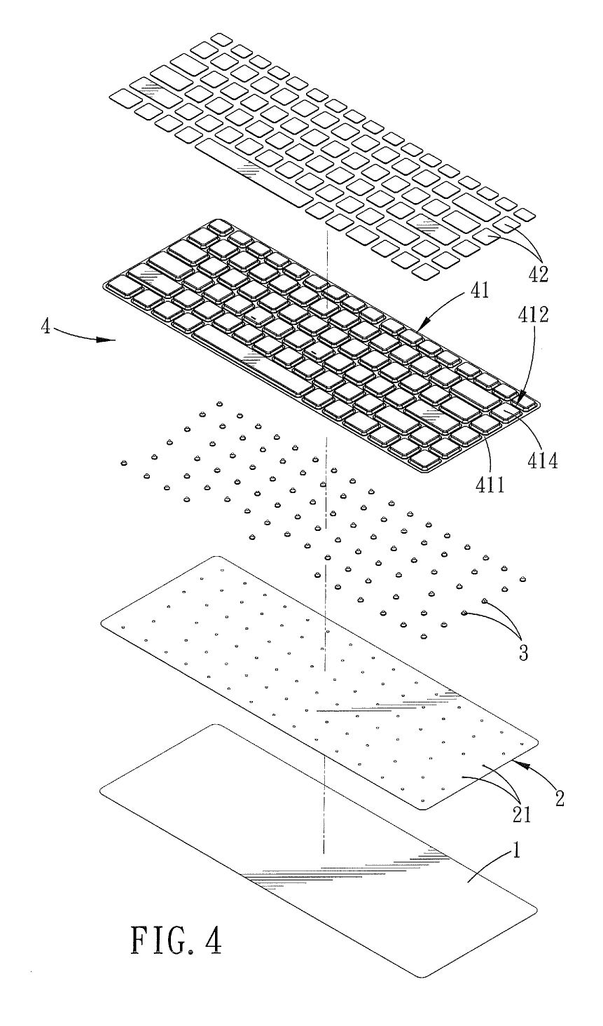

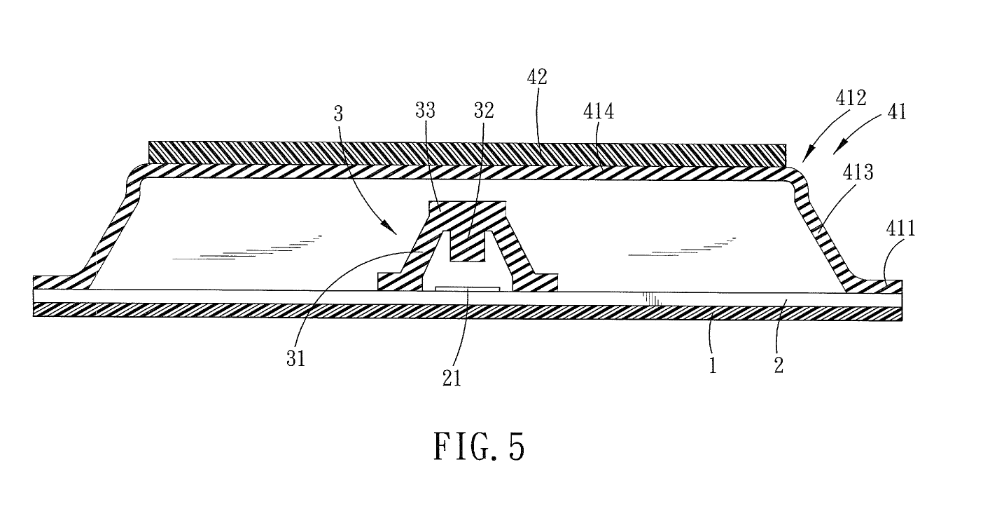

FIGS. 4 and 5 illustrate the second embodiment of the keyboard of the present invention. The second embodiment differs from the first embodiment only in that the reinforcing plates 42 are respectively disposed over upper surfaces of the press walls 414 of the keycap portions 412.

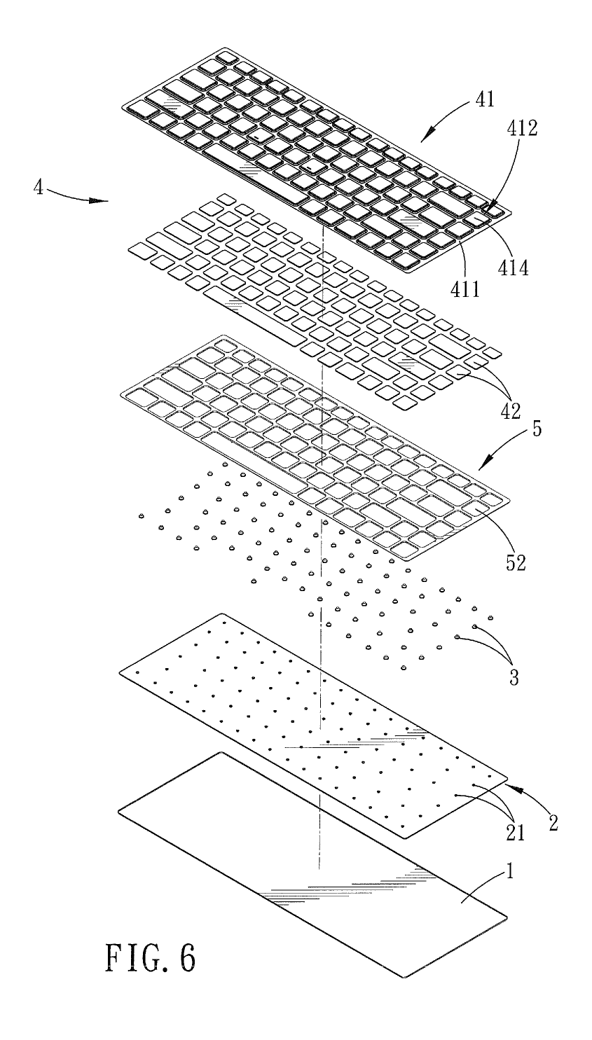

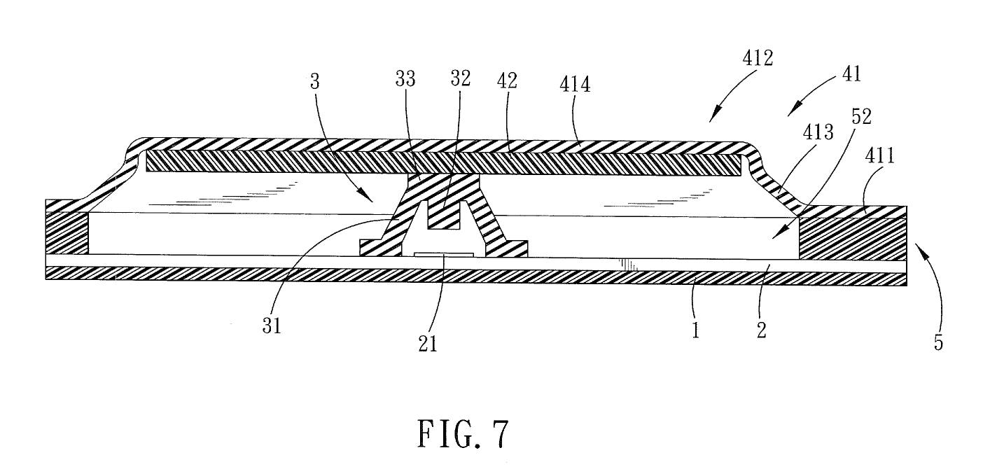

FIGS. 6 and 7 illustrate the third embodiment of the keyboard of the present invention. The third embodiment differs from the first embodiment only in that the keyboard further comprises a supporting film 5 disposed between and adhered to the membrane 41 of the press key set 4 and the membrane circuit substrate 2.

The supporting film 5 is made of a rigid material and is formed with a plurality of through holes 52 for extension of the elastic members 3. With the provision of the supporting film 5, the height of the surrounding walls 413 can be reduced, and the rigidity of the connecting portion 411 of the membrane 41 can be enhanced.

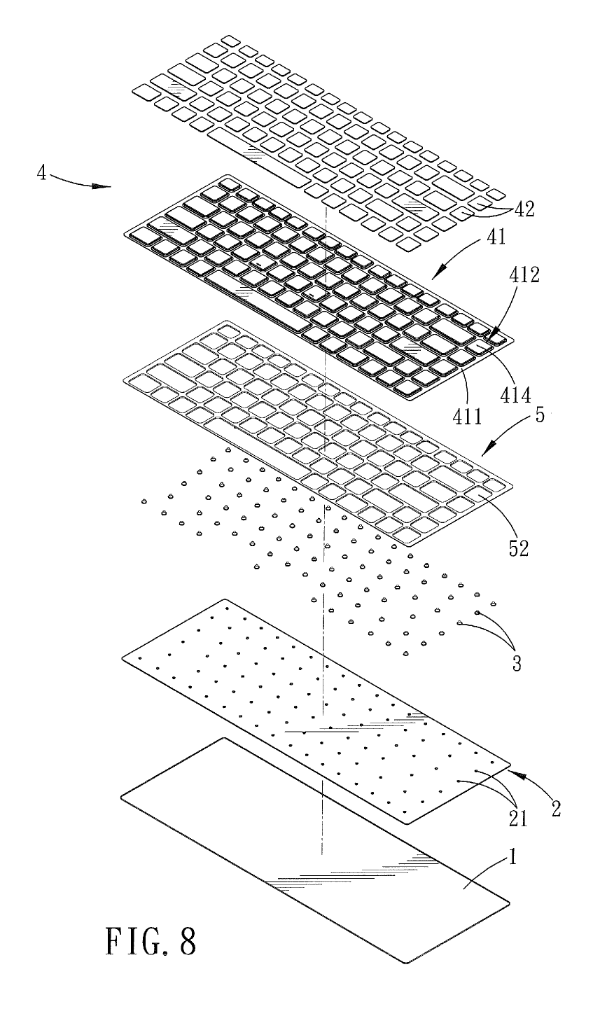

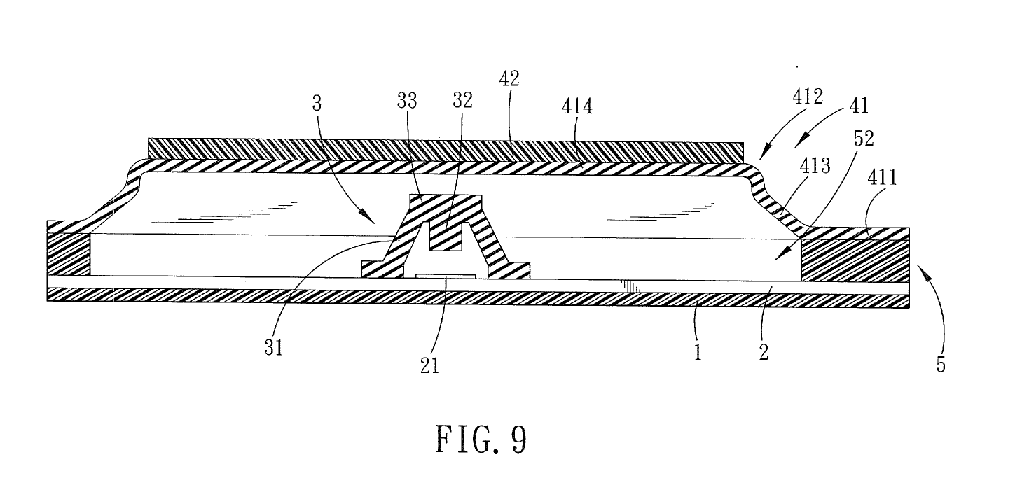

FIGS. 8 and 9 illustrate the fourth embodiment of the keyboard of the present invention. The fourth embodiment differs from the third embodiment only in that the reinforcing plates 42 are respectively disposed over upper surfaces of the press walls 414 of the keycap portions 412.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A keyboard, comprising:
a membrane circuit substrate;
a press key set including a one-piece membrane and a plurality of rigid reinforcing plates, said membrane having a plurality of resilient keycap portions and a connecting portion extending among and interconnecting said keycap portions, said connecting portion being fixed to said membrane circuit substrate, said keycap portions protruding upwardly from said connecting portion, each of said keycap portions having a press wall, and a surrounding wall extending downwardly from said press wall to said connecting portion, each of said reinforcing plates being disposed over said press wall of a corresponding one of said keycap portions; and
a plurality of elastic members each of which is disposed between said press wall and said membrane circuit substrate.

2. The keyboard of claim 1, wherein each of said reinforcing plates has an area not larger than that of said press wall of the corresponding one of said keycap portions.

3. The keyboard of claim 1, further comprising a supporting film disposed between said membrane of said press key set and said membrane circuit substrate, said supporting film being formed with a plurality of through holes for extension of said elastic members.

4. The keyboard of claim 1, wherein said reinforcing plates are respectively disposed over upper surfaces of said press walls of said keycap portions.

5. The keyboard of claim 1, wherein said reinforcing plates are respectively disposed over lower surfaces of said press walls of said keycap portions.
